(19) United States
(12) Patent Application Publication
(10) Pub. No.: US 2005/0128385 A1
(43) Pub. Date: Jun. 16, 2005

(54) Pixel structure for a liquid crystal on silicon display

(76) Inventor: Hong-Da Liu, Jubei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/733,277

(22) Filed: Dec. 12, 2003

(51) Int. Cl. G02F 1/1335

(52) U.S. Cl. 349/113

(57) ABSTRACT

A pixel structure for an LCoS display comprises a pixel electrode, an insulator formed on the pixel electrode by CMP, reflectors formed on the insulator by micro-electro-mechanical process, a passivation formed on the reflectors and the insulator by CMP, a conductor on the passivation, a layer of liquid crystal above the conductor, and a glass plate having common electrode thereon above the layer of liquid crystal. Each of the reflectors has an oblique metal plate, gratings or a planar metal plate with multilayer coating of different refractive indexes thereon, so as to reflect an oblique incident light for a reflective light produced at specific angles by diffraction or refraction and out of the glass plate.

### FIELD OF THE INVENTION

The present invention relates generally to a liquid crystal on silicon (LCoS) display, and more particularly, to a pixel structure of an LCoS display.

### BACKGROUND OF THE INVENTION

LCoS is the critical technology for next generation of reflective LC projector and rear projection television (TV), and has the most advantages of dramatically reducing the manufacture cost of display panel while achieving high resolution. The distinction between LCoS and thin film transistor (TFT) liquid crystal display (LCD) is that both of top and bottom substrates of TFT-LCD are glass plates, but only top substrate of LCoS is glass plate. The bottom substrate of LCoS is silicon semiconductor, and thus LCoS is a technology combining LCD with semiconductor CMOS process.

FIG. 1 shows a pixel structure 10 of a conventional LCoS, which comprises a pixel electrode 114, an insulator 112 on the pixel electrode 114, three planar reflectors 110 on the insulator 112, a layer of liquid crystal 104 above the reflectors 110 and the insulator 112, and a glass plate 102 above the layer of liquid crystal 104. The incident light 116 is vertically incident into the glass plate 102 and is vertically reflected out of the glass plate 102 by the reflectors 110. Due to the optical paths of the incident light 116 and the reflective light 118 are identical or similar, this conventional structure needs optical device such as splitter to separate the incident light 116 and reflective light 118, resulting in reduced brightness and contrast.

Therefore, it is desired a pixel structure for an LCoS which separates the optical paths of the incident light and the reflective light so as to enhance the light throughput and contrast.

### SUMMARY OF THE INVENTION

Accordingly, one object of the present invention is to provide a pixel structure of an LCoS that diffracts or refracts an oblique incident light at specific angles out of the glass plate in the LCoS display.

Another object of the present invention is reflecting an oblique incident light at specific angles out of the glass plate in the LCoS display by diffraction or refraction by reflectors with reflective surface in different slopes.

Yet another object of the present invention is reflecting an oblique incident light at specific angles out of the glass plate in the LCoS display by diffraction or refraction by gratings with length close to or shorter than the wavelength of the incident light.

Still another object of the present invention is reflecting an oblique incident light at specific angles out of the glass plate in the LCoS display by diffraction or refraction by reflectors coated with multilayer coatings of different refractive indexes.

In a pixel structure for an LCoS display, according to the present invention, an insulator is formed on a pixel electrode by chemically mechanical polishing (CMP), several reflectors on the insulator, a passivation formed on the reflectors and insulator, a transparent conductor on the passivation, a layer of LC above the conductor, and a glass plate above the layer of liquid crystal.

In one embodiment, the reflector includes one or more oblique metal plates or high reflective multilayer coatings to reflect the oblique incident light to produce the reflective light at specific angles by diffraction or refraction out of the glass plate. In another embodiment, the reflector includes optical gratings or multilevel diffractive reflector to reflect the oblique incident light. In still another embodiment, the reflector includes a planar reflective surface with one or more coatings thereon to reflect the oblique incident light.

### BRIEF DESCRIPTION OF THE DRAWINGS

The above and other objects, features and advantages of the present invention will become apparent to those skilled in the art upon consideration of the following description of the preferred embodiments of the present invention taken in conjunction with the accompanying drawings, in which:

FIG. 1 shows a pixel structure of a conventional LCoS;

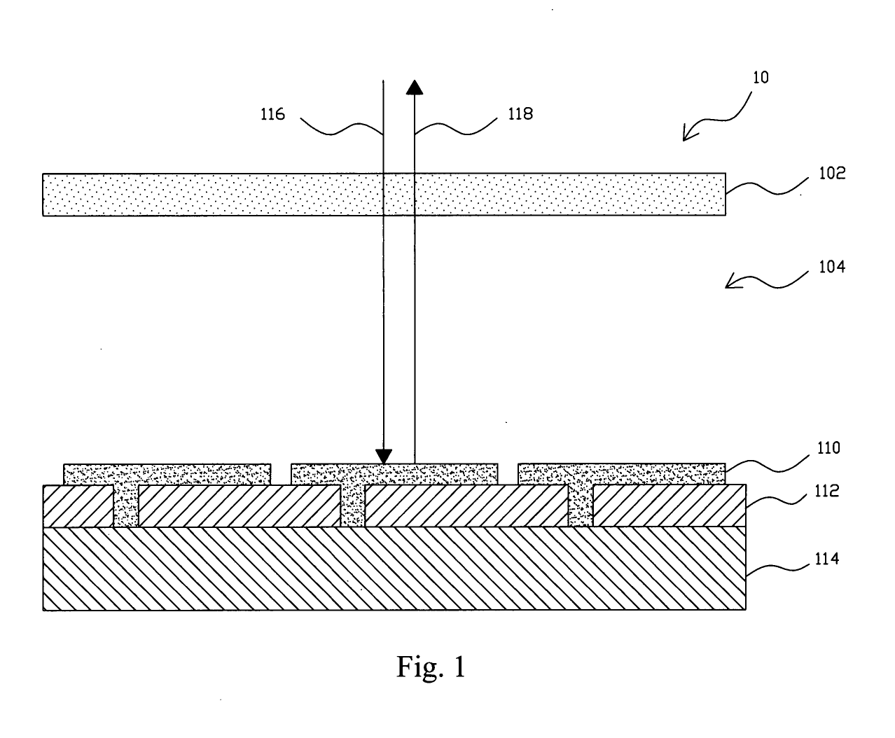

FIG. 2 shows the simplified cross-sectional view of an embodiment pixel structure for an LCoS according to the present invention;

FIG. 3 shows a variation of the pixel structure shown in FIG. 2;

FIG. 4 shows a further variation of the pixel structure shown in FIG. 2;

FIG. 5 shows a variation of the pixel structure shown in FIG. 4;

FIG. 6 shows a further variation of the pixel structure shown in FIG. 4;

FIG. 7 shows the simplified cross-sectional view of another embodiment pixel structure for an LCoS according to the present invention;

FIG. 8 is an enlarged view of the optical grating in FIG. 7;

FIG. 9 shows a variation of the pixel structure shown in FIG. 7;

FIG. 10 shows a further variation of the pixel structure shown in FIG. 7;

FIG. 11 shows a variation of the pixel structure shown in FIG. 10;

FIG. 12 shows the relation between the incident angle and the period of the optical grating;

FIG. 13 shows the simplified cross-sectional view of yet another embodiment pixel structure for an LCoS according to the present invention;

FIG. 14 shows a variation of the pixel structure shown in FIG. 13; and

FIG. 15 shows a variation of the pixel structure shown in FIG. 14.

### DETAILED DESCRIPTION OF THE INVENTION

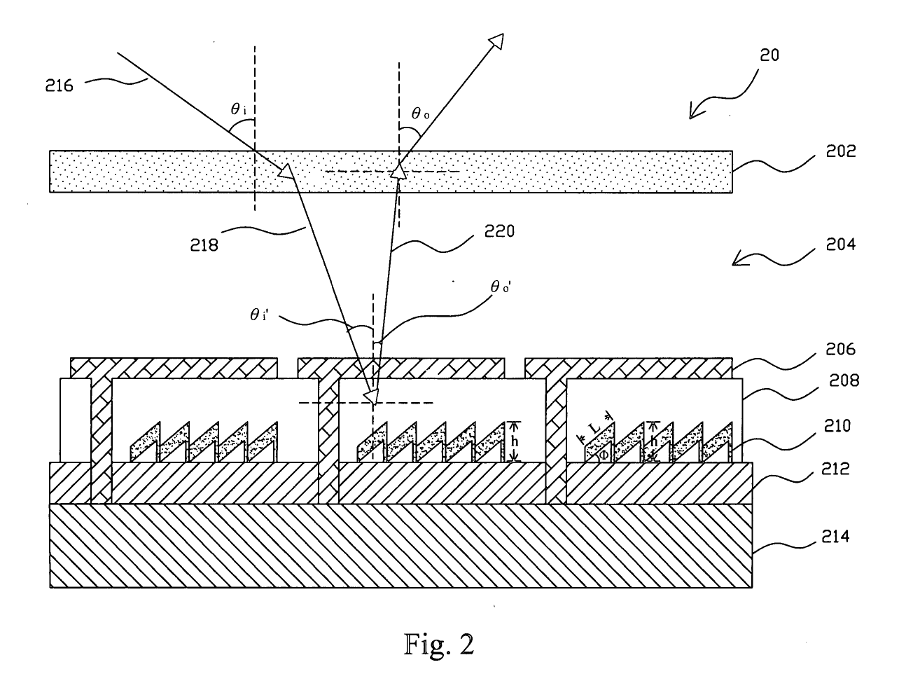

FIG. 2 shows the simplified cross-sectional view of an embodiment pixel structure for an LCoS according to the present invention. A pixel structure comprises a pixel electrode 214, an insulator 212 formed on the pixel electrode 214 by CMP, several reflectors 210 on the insulator 212 to reflect an oblique incident light 216, a passivation 208 formed on the reflectors 210 and insulator 212 by CMP, a conductor 206 on the passivation 208, a layer of liquid crystal 204 above the conductor 206, and a glass plate 202 above the layer of liquid crystal 204. The conductor 206 is directly connected to the pixel electrode 214. The angles Φ between each of the reflectors 210 and the insulator 212 are the same, and the lengths L and heights h of the reflectors 210 are also the same. The reflector 210 includes a high reflective metal such as Al, Ag or their alloy. Alternatively, the reflector 210 may be formed with multilayer coatings of high reflectivity. As shown in FIG. 2, the incident light 216 is incident into the glass plate 202 with an incident angle θᵢ, and after refracted by the glass plate 202, the light 218 becomes at an angle θᵢ′. The refractive light 218 reaches the reflector 210 through the layer of LC 204, the conductor 206 and the passivation 208, and reflected by the reflector 210 to produce the reflective light 220 at an angle θₒ′. The reflective light 220 passes through the glass plate 202 and has a final output angle θₒ. The output angle θₒ is in the range of 0 to 65 degrees, the incident angle θᵢ′ within the pixel 20 is in the range of 10 to 80 degrees, and the reflected angle θₒ′ within the pixel 20 is in the range of 0 to 45 degrees. On the other hand, each oblique reflector 210 has a height h of 0.05 to 5 μm and a length L of 0.05 to 15 μm, and the incident angle Φ is in the range of 0.5 to 45 degrees. When the length L of the reflector 210 is larger than the wavelength λ of the incident light 218, for example with the ratio of L/λ larger than 20, the reflection caused by the reflector 210 will not appears obvious diffraction. While the length L of the reflector 210 is smaller than or close to the wavelength λ of the incident light 218, for example with the ratio of L/λ between 0 and 20, the reflection caused by the reflector 210 will have obvious diffraction to enhance the light throughput and contrast. In this embodiment, due to the incident angles Φ to each reflector 210 and insulator 212 all the same, the panel can only reflect the incident light at one color or one specific wavelength, and thus three panels are used to separately modulate the reflective brightness of red, green and blue lights. In addition, the height h or the length L of the reflectors 210 can be arranged in an order or in a regular distribution.

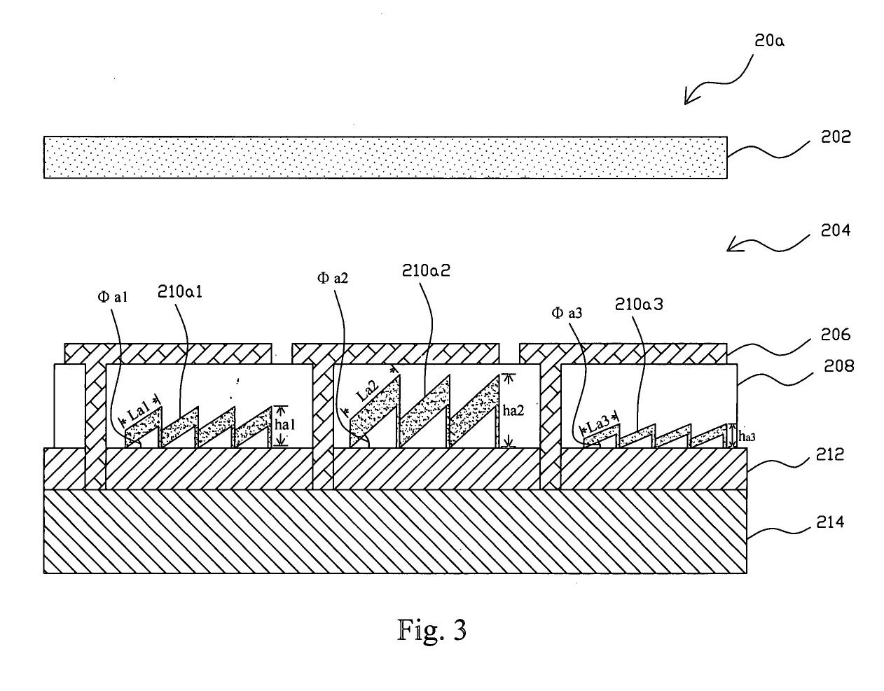

FIG. 3 shows a variation of the pixel structure shown in FIG. 2, where a pixel structure 20a is similar to the pixel structure 20 of FIG. 2 in that they both have a pixel electrode 214, an insulator 212, several reflectors, a passivation 208, a conductor 206, a layer of LC 204, and a glass plate 202. However, the reflectors of the pixel 20a are divided into three groups 210a1, 210a2 and 210a3 with an oblique angles Φₐ₁, Φₐ₂ and Φₐ₃ between each of them and the insulator 212, and the lengths Lₐ₁, Lₐ₂ and Lₐ₃ and the heights hₐ₁, hₐ₂ and hₐ₃ of them are also different. Moreover, the number of the reflectors in each group may be also different, i.e. at different densities of distributions. As a result, this embodiment can reflect three color lights by the varied reflectors. Likewise, if the ratios Lₐ₁/λₐ₁, Lₐ₂/λₐ₂ and Lₐ₃/λₐ₃ of the lengths Lₐ₁, Lₐ₂ and Lₐ₃ of the reflectors to the wavelengths λₐ₁, λₐ₂ and λₐ₃ of the incident lights are all larger than 20, the diffraction effect will be nonobvious. However, the refraction and reflection effects can be used for reflecting light at specific angles to enhance the light throughput and contrast. In contrast, if the ratios Lₐ₁/λₐ₁, Lₐ₂/λₐ₂ and Lₐ₃/λₐ₃ lie in the range of 0 to 20, the diffraction effect will be obvious for the light reflection and thus to enhance the light throughput and contrast. Moreover, the lengths Lₐ₁, Lₐ₂ and Lₐ₃ and the heights hₐ₁, hₐ₂ and hₐ₃ of the reflectors 210a1, 210a2 and 210a3 arranged in an order or in a regular distribution.

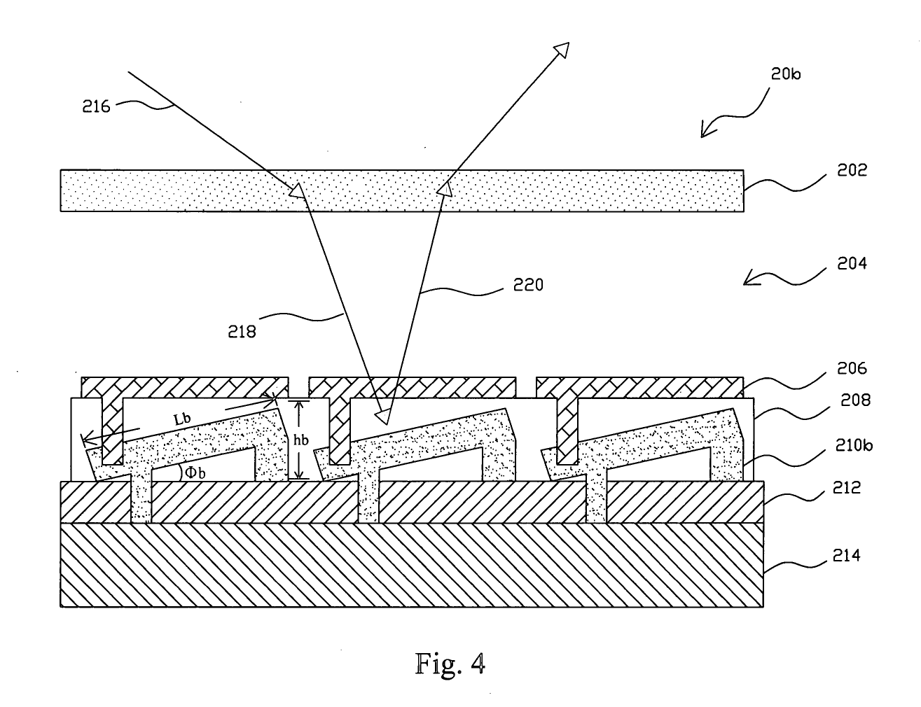

FIG. 4 shows a further variation of the pixel structure shown in FIG. 2, where a pixel structure 20b is similar to the pixel structure 20 of FIG. 2 in that they both have a pixel electrode 214, an insulator 212, a passivation 208, a conductor 206, a layer of LC 204, and a glass plate 202. However, the reflectors of the pixel 20b include only three oblique reflectors 210b each having a same length L_{b} and a same height h_{b} and a same oblique angle Φ_{b} to the insulator 212, thereby one panel of this embodiment only reflects one color light. Again, when the length L_{b} of the reflector 210b is larger than the wavelength λ of the incident light 218, i.e., the ratio L_{b}/λ is larger than 20, no obvious diffraction appears to the reflective light 220, while the refraction and reflection effects can be used for reflecting light at specific angles to enhance the light throughput and contrast. If the length L_{b} of the reflector 210b is smaller or near to the wavelength λ of the incident light 218, i.e., the ratio L_{b}/λ between 0 and 20, obvious diffraction appears to the reflective light 220 and thus to enhance the light efficiency and contrast.

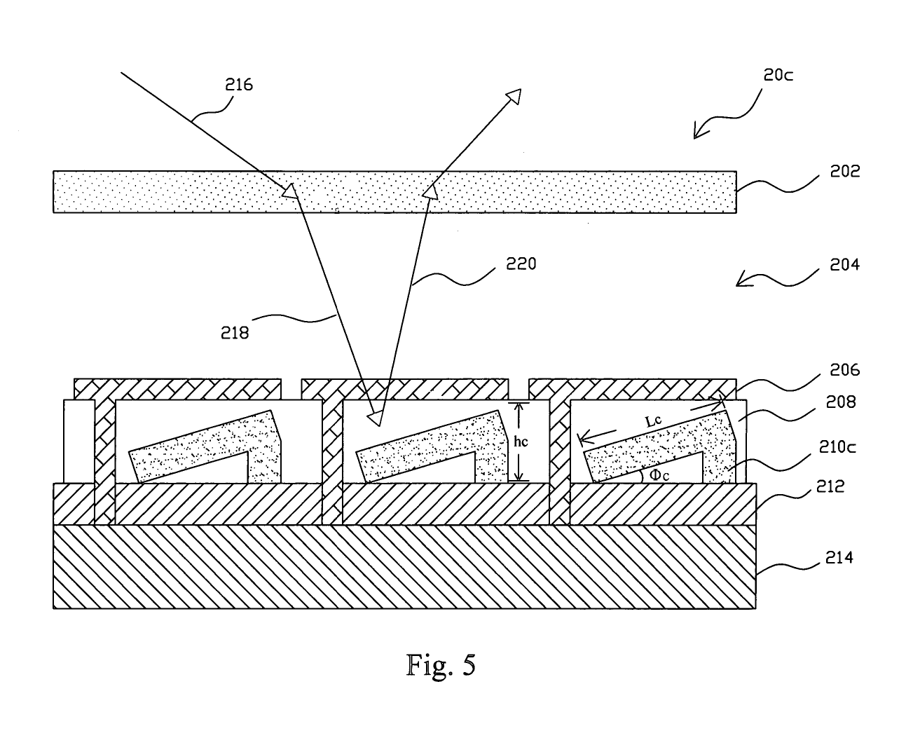

FIG. 5 shows a variation of the pixel structure shown in FIG. 4 with the difference that the conductor 206 in FIG. 4 is connected to the pixel electrode 214 through the conductive reflector 210c, while the conductor 206 in FIG. 5 is directly connected to the pixel electrode 214.

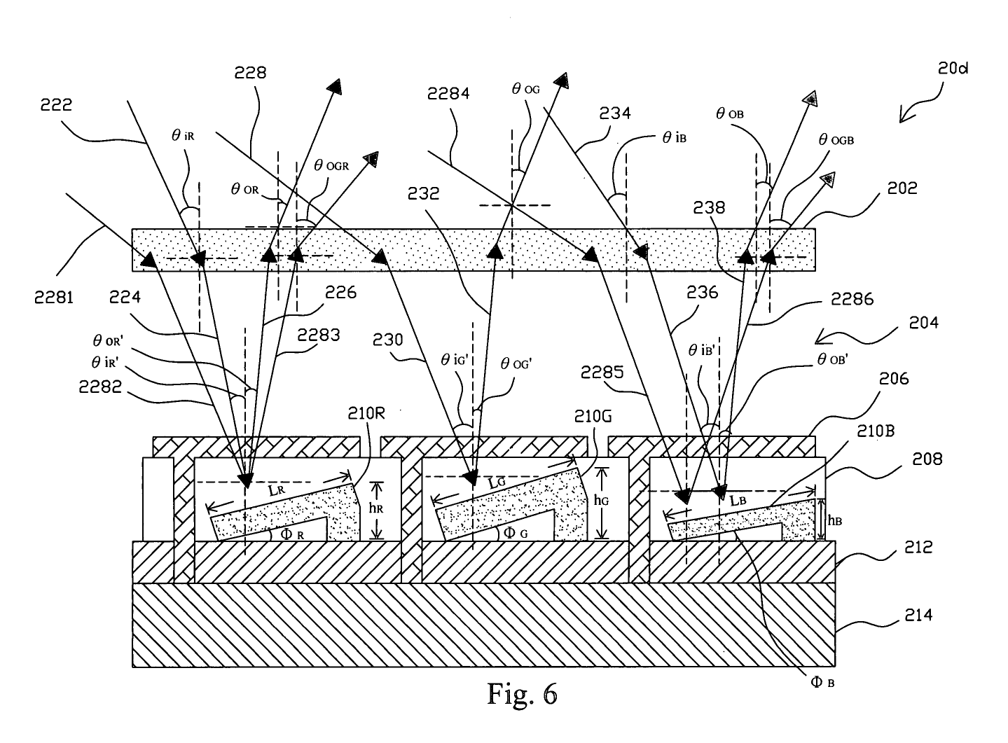

FIG. 6 shows a further variation of the pixel structure shown in FIG. 4, where the included angles Φ_{R}, Φ_{G} and Φ_{B} of the reflectors 210R, 210G and 210B to the insulator 212 are all different to each other, and the lengths L_{R}, L_{G} and L_{B} and height h_{R}, h_{G} and h_{B} of the reflectors 210R, 210G and 210B are also different to each other. Therefore, one panel can reflect three color lights in this embodiment. As shown, a red incident light 222 with an incident angle θ_{iR} produces a refractive light 224 with an angle θ_{iR}′ after refracted by the glass plate 202. The refractive light 224 traverses through the LC 204, the conductor 206 and the passivation 208 to the reflector 210R, and reflected by the reflector 210R to produce the reflective light 226 at an angle θ_{oR}′, which is further refracted to an angle θ_{oR} out of the glass plate 202. Similarly, the green incident light 228 and the blue incident light 234 become the refractive lights 230 and 236 after refracted by the glass plate 202, and further become the reflective lights 232 and 238 after reflected by the reflectors 210G and 210B, which are further refracted out of the glass plate 202 at specific angles θ_{oG} and θ_{oB}. The angles θ_{oR}, θ_{oG} and θ_{oB} all lie in the range of 0 to 45 degrees. The reflectors 201R, 210G and 210B each can only reflect the red, green or blue lights individually, and imposes no effect to the other two color lights. For example, when the green incident lights 2281 and 2284 become the refractive lights 2282 and 2285 after refracted, and further become the reflective lights 2283 and 2286 after reflected by the reflectors 210R and 210B, the reflective lights 2283 and 2286 are finally refracted by the glass plate 202 at alternative angles θ_{oGR} and θ_{oGB}, thereby inducing no effect for the angles θ_{oGR} and θ_{oGB} different from the proper θ_{oG}.

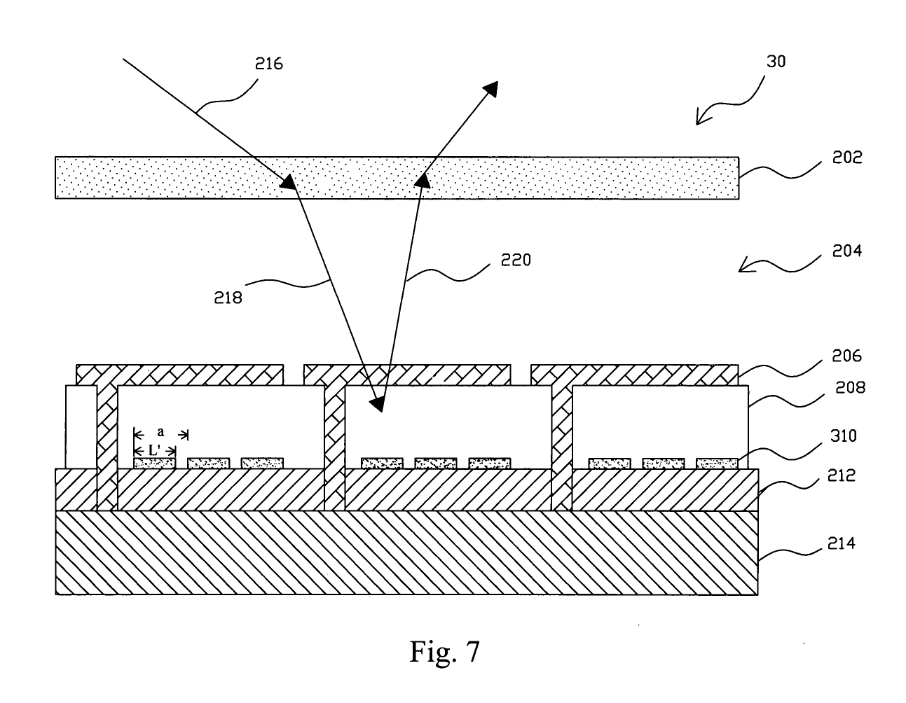

FIG. 7 shows the simplified cross-sectional view of another embodiment pixel structure for an LCoS according to the present invention. Likewise, a pixel structure 30 comprises a pixel electrode 214, an insulator 212, several reflectors 310, a passivation 208, a conductor 206, a layer of LC 204, and a glass plate 202. However, optical gratings 310 are used for the reflectors herewith. The incident light 216 produces a refractive light 218 after refracted by the glass plate 202, and the ratio L′/λ of the length L′ of each optical grating 310 and the wavelength λ of the incident light lies in the range of 0 to 20 to thereby reflect the refractive light 218 with obvious diffraction. Then the reflective light 220 is refracted out of the glass plate 202 at a specific angle with enhanced light efficiency and contrast. In this embodiment, each period a of the gratings 310 has the same value, and the pixel structure 30 can only reflect one color light for one panel. Moreover, the lengths L′ of each optical grating 310 are distributed equally or regularly.

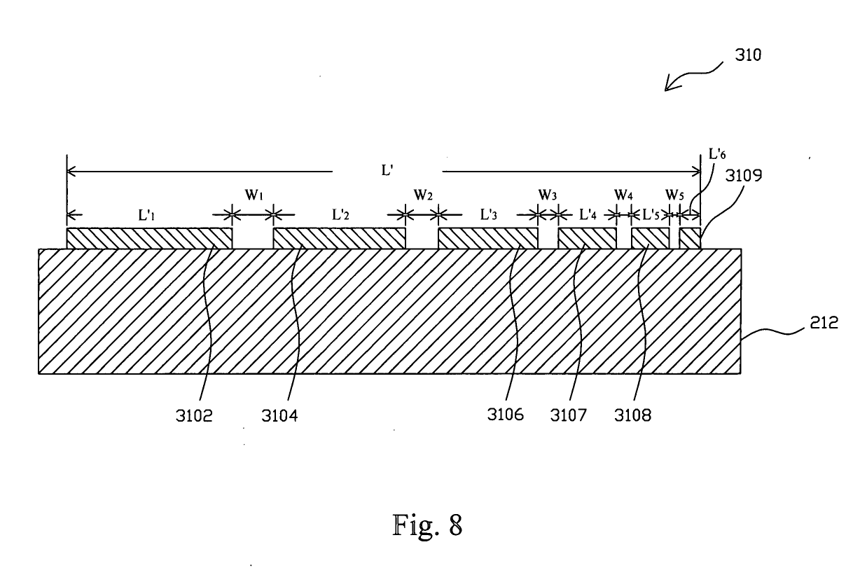

FIG. 8 is an enlarged view of the optical grating 310 in FIG. 7, which includes a series of strip metals arranged regularly or periodically on the insulator 212. Particularly, the lengths of the strip metals 3102, 3104, 3106, 3107, 3108 and 3109 are L′₁, L′₂, L′₃, L′₄, L′₅ and L′₆, respectively, and the gaps between each two adjacent strip metals are w1, w2, w3, w4 and w5, respectively, where both the lengths L′₁, L′₂, L′₃, L′₄, L′₅ and L′₆ and the gaps w1, w2, w3, w4 and w5 decrease gradually in an order. As a result, the lengths, gaps and direction of arrangement will affect the angle and direction of reflective light.

For illustration, the parameters and effects observed on the pixel structure 30 of FIG. 7 when the incident light 216 has a wavelength of 500 nm and an output angle θₒ is 0 degree are listed in Table 1. The relation between the incident angle θᵢ and period a of the grating 310 is

TABLE 1

| Incident Angle θᵢ | Period a (um) |
|---|---|
| 10 | 3.16729 |
| 15 | 2.12503 |
| 20 | 1.60809 |
| 25 | 1.30141 |
| 30 | 1.1 |
| 35 | 0.95889 |
| 40 | 0.85565 |
| 45 | 0.77781 |

According to Table 1, the period a determines the incident light angles, and when the period a is smaller the incident light angle is larger.

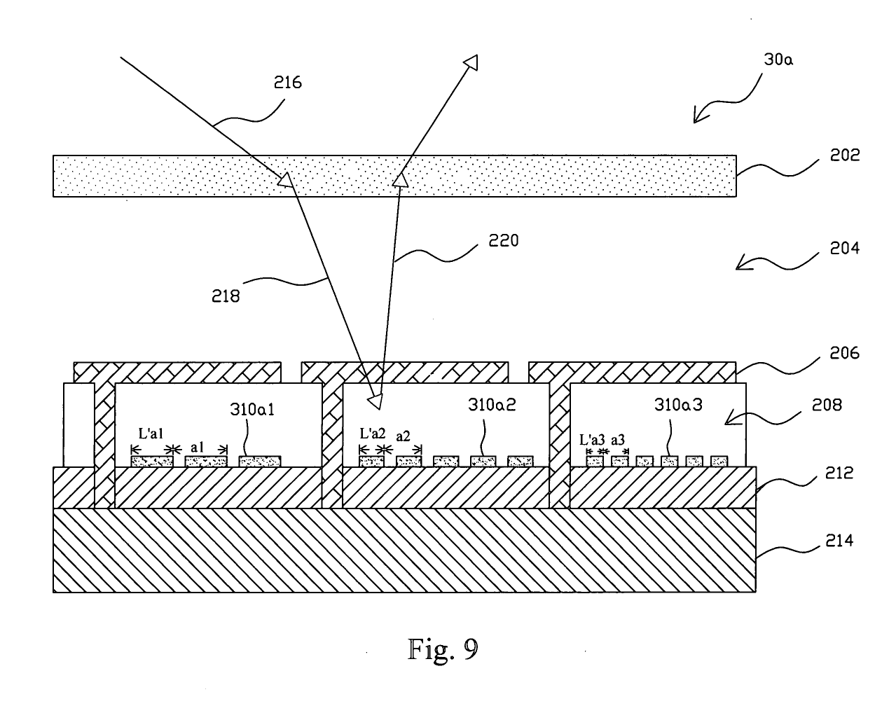

FIG. 9 shows a variation of the pixel structure shown in FIG. 7. The pixel structure 30a hereof is noted that the optical gratings are divided into three groups 310a1, 310a2 and 310a3, with different periods a1, a2 and a3 and lengths L′ₐ₁, L′ₐ₂ and L′ₐ₃ thereof, and the number of the optical gratings in the respective group are also different, i.e., different densities of distributions, thereby three color lights can be reflected by one panel of this embodiment.

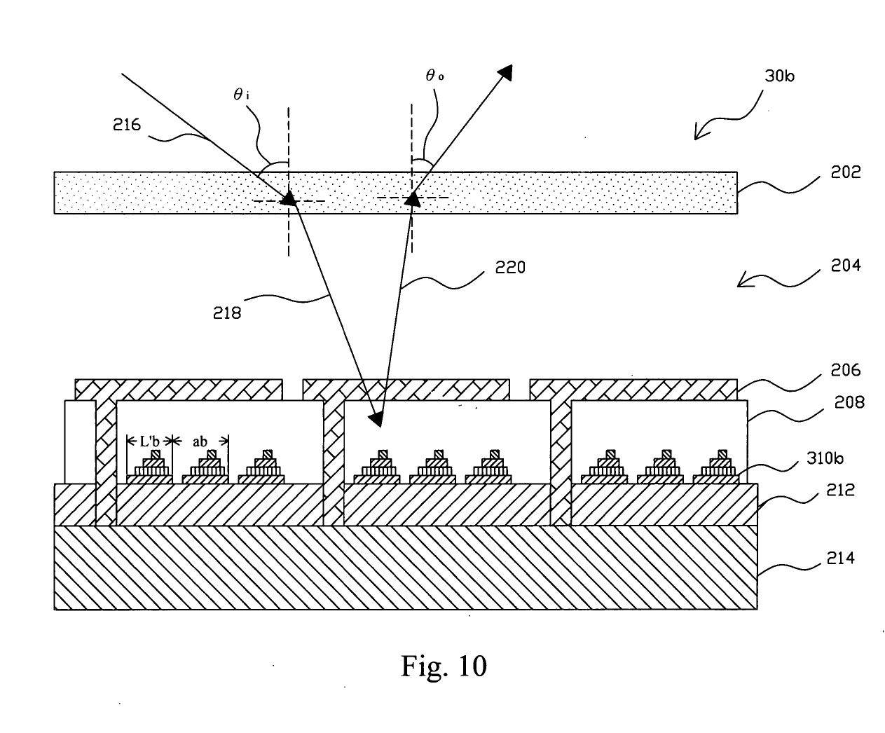

FIG. 10 shows a further variation of the pixel structure shown in FIG. 7. Particularly, each optical grating 310b hereof includes a plurality of metals in stack on the insulator 212. Similarly, the ratio L′_{b}/λ of the length L′_{b} of the optical grating 310b to the wavelength λ of the incident light 216 lies in the range of 0 to 20, and thus the diffraction effect is produced and much more than that in FIG. 7. In this embodiment, each period a_{b} has the same value, and one panel can therefore reflect only one color light. Moreover, the length of each optical grating 310b is selected regularly or periodically. The optical grating 310b in this embodiment can be also formed with one layer of metal and multilayer coatings thereon, or a multilayer coating of high reflectivity, in which each coating has a different refractive index.

For illustration, the parameters and effects observed on the pixel structure 30b of FIG. 10 when the incident light 216 has a wavelength of 550 nm and an output angle θₒ is 15 or 30 degrees are listed in Table 2. Modulating the period a_{b} and the incident angle θᵢ, the first and second order diffractive ratio of the incident light 216 is

TABLE 2

| Period a_{b} | Reflective Angle θₒ | Height | 1R | 2R |
|---|---|---|---|---|
| 0.6 | 15 | 0.4 | 0.874129 | |
| 0.7 | 15 | 0.4 | 0.92764 | |
| 0.8 | 15 | 0.4 | 0.92043 | |
| 0.9 | 15 | 0.4 | 0.858215 | |
| 0.6 | 30 | 0.4 | 0.96468 | |
| 0.7 | 30 | 0.4 | 0.94933 | |
| 0.8 | 30 | 0.4 | 0.882393 | |
| 0.9 | 30 | 0.4 | 0.865683 | |
| 1 | 30 | 0.4 | 0.853313 | |
| 0.6 | 30 | 0.5 | 0.89832 | |
| 1 | 30 | 0.7 | | 0.868452 |
| 1 | 30 | 0.8 | | 0.91208 |

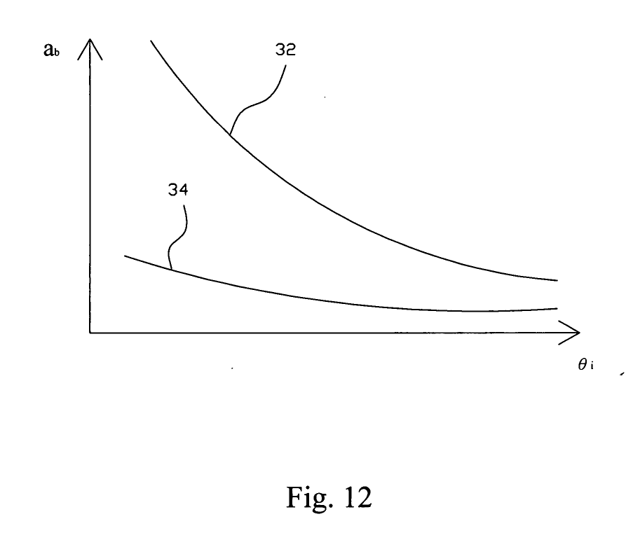

In Table 2, 1R and 2R denote the diffractive ratios for the first and second order to the incident light 218. The better range of diffraction effect in Table 2 can be determined by

$$\begin{matrix}y = 0.8 + 5.1 \times {ⅇ}^{- ( \frac{x - 5.5}{7.6} )} , and & [ EQ \text{-} 1 ] \\ y = 0.1 + 4.6 \times {ⅇ}^{- ( \frac{x - 0.4}{27} )} , & [ EQ \text{-} 2 ]\end{matrix}$$

where, y is the incident angle θᵢ, and x is the period a_{b}. FIG. 12 shows the curves 32 and 34 for the equations EQ-1 and EQ-2, respectively, and the better range for diffraction effect is among that between the curves 32 and 34.

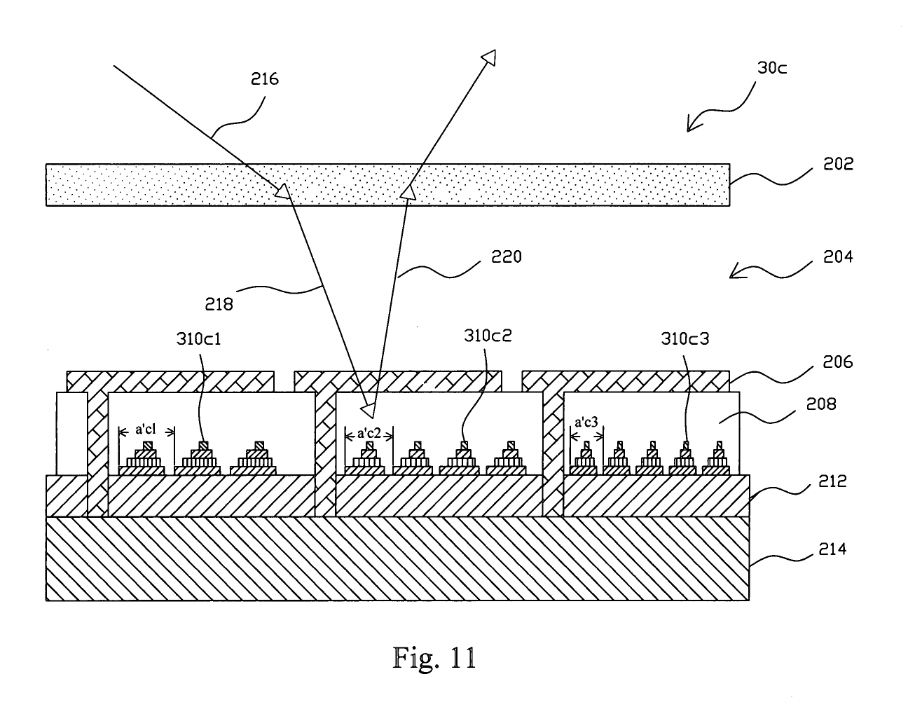

FIG. 11 shows a variation of the pixel structure shown in FIG. 10. The pixel structure 30b hereof is noted in that the multilevel diffractive reflectors are divided into three groups 310c1, 310c2 and 310c3, with different number and length of multilayer in stack and the periods a′_{c}1, a′_{c}2 and a′_{c}3 thereof. In this embodiment, one panel can reflect three color lights.

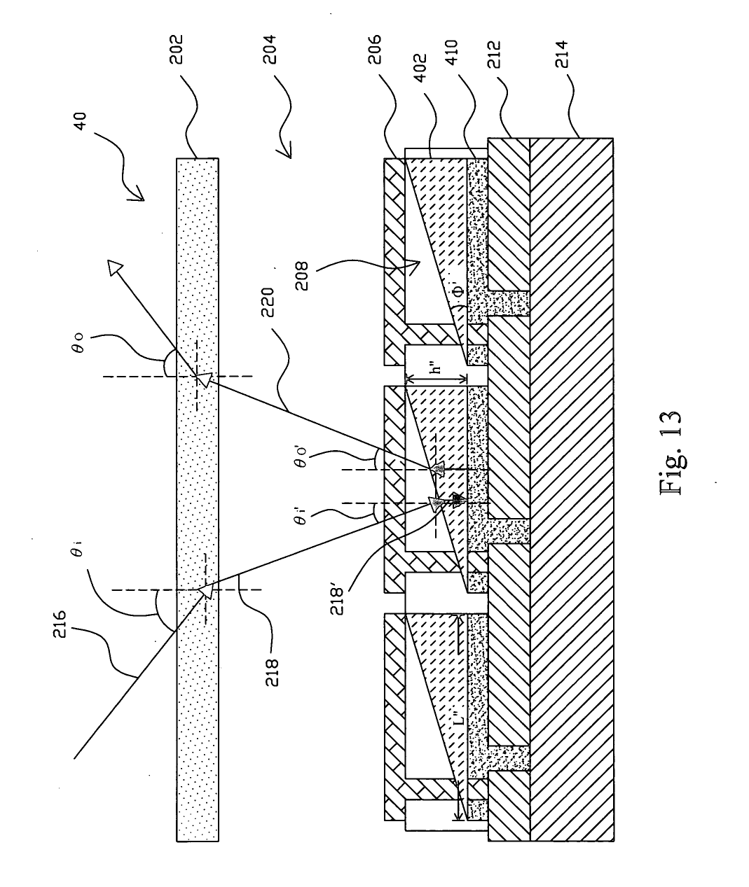

FIG. 13 shows the simplified cross-sectional view of yet another embodiment pixel structure for an LCoS according to the present invention. The pixel structure 40 hereof is similar to the foregoing embodiments, except that three planar reflectors 410 are used and a microprism 402 (or air) is buried in the passivation 208 and above the planar reflectors 410. Each microprism 402 has an angle Φ′ (or a slope), a length L″ and a height h″. The refractive index of the passivation 208 is n₁, and that of the microprism 402 is n₂, where n₁ is not equal to n₂, and n₁-n₂ is larger or equal to 0.02. After the incident light 216 refracted by the glass plate 202, the refractive light 218 arrives the microprism 402 through the layer of LC 204, the conductor 206 and the passivation 208. The refractive light 218′ perpendicular to the planar reflector 410 is produced after the refractive light 218 is refracted by the microprism 402, with an angle θₒ′ after reflected by the reflector 410 and refracted once again by the microprism 402, and finally refracted out of the glass plate 202 with the output angle θₒ. If the ratio L″/λ of the length L″ of the microprism 402 and the wavelength λ of the incident light 216 is larger than 20, the diffraction will not appear. In this case the refraction and reflection effects can be used to reflect the light to specific angles to enhance the light efficiency and contrast. If the ratio L″/λ lies in the range of 0 to 20, obvious diffraction will appear and enhance the light efficiency and contrast. Moreover, since the angle Φ′ (or slope), length L″ and height h″ of the microprisms 402 in each and other reflectors are all the same, the panel reflects only one color light in this embodiment.

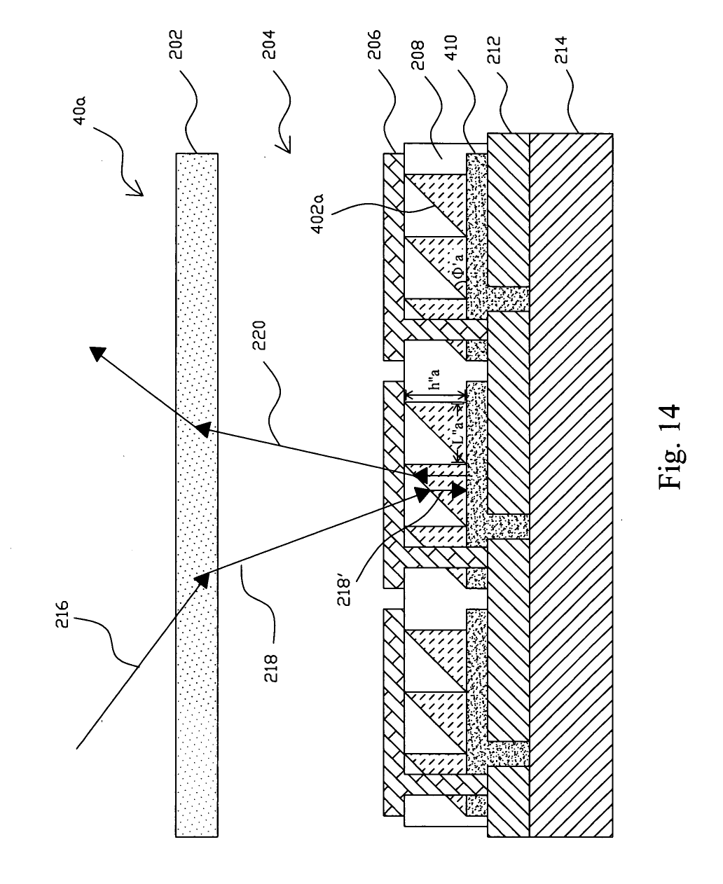

FIG. 14 shows a variation of the pixel structure shown in FIG. 13. The pixel structure 40a in FIG. 14 includes several microprism 402a buried in each planar passivation 208. If the ratio L″/λ of the length L″ of the microprism 402a and the wavelength λ of the incident light 216 is larger than 20, diffraction effect will not appear but refraction effect will. If the ratio L″/λ is in the range of 0 to 20, diffraction effect will appear and can be used to enhance the light efficiency and contrast. Moreover, since the angle Φ′ₐ (or slope), length L″ₐ and height h″ₐ of each reflector is same, the pixel structure 40a reflects one color light.

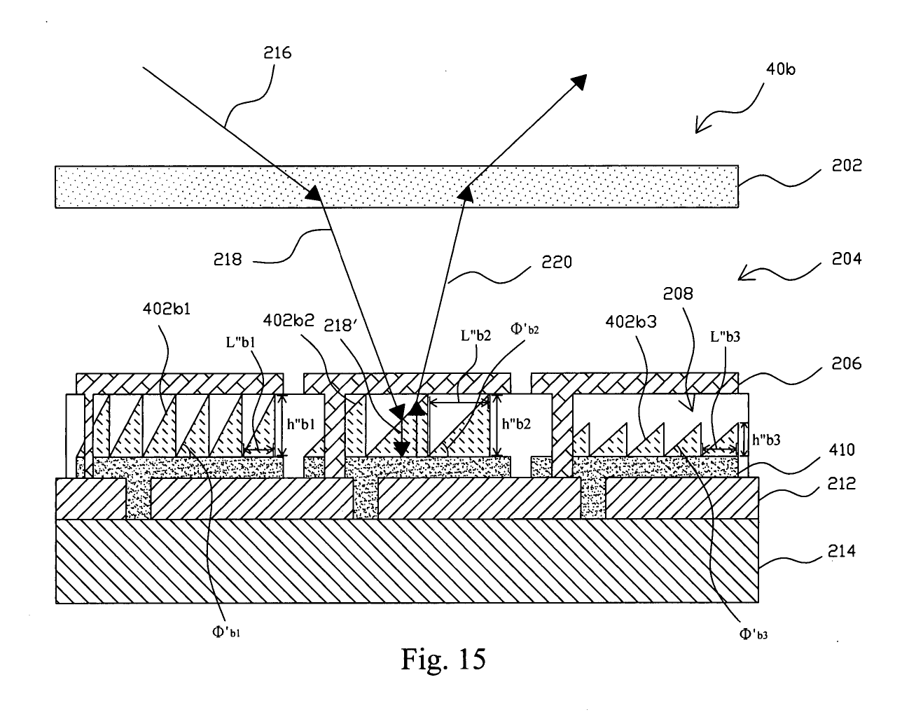

FIG. 15 shows a variation of the pixel structure shown in FIG. 13. For the reflectors hereof, the lengths L″_{b1}, L″_{b2} and L″_{b3}, the heights h″_{b1}, h″_{b2} and h″_{b3}, and angles Φ′_{b1}, Φ′_{b2} and Φ′_{b3} of the microprisms 402b1, 402b2 and 402b3 are all different, and the number (or density) of the microprisms 402b1, 402b2 and 402b3 are also different. Therefore, the pixel structure 40b in this embodiment can reflect three color lights at the same time. If the ratios L″_{b1}/λ, L″_{b2}/λ and L″_{b3}/λ of the lengths L″_{b1}, L″_{b2} and L″_{b3} of the microprisms 402b1, 402b2 and 402b3 in contact with the reflector 410 to the wavelength λ of the incident light 216 are larger than 20, diffraction effect will not appear but refraction and reflection effect can be used to reflect the light at specific angles. If the ratios L″_{b1}/λ, L″_{b2}/λ and L″_{b3}/λ lie in the range of 0 to 20, diffraction will appear and can be used to enhance the light efficiency and contrast. Moreover, the microprisms 402b1, 402b2 and 402b3 on each reflector can be arranged regularly or periodically, and the distribution of microprisms 402b1, 402b2 and 402b3 on each and other reflectors can be different.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

1. A pixel structure for an LCoS display to reflect an incident light at an incident angle to an output light at an output angle, the pixel structure comprising:
a glass plate for refracting the incident light to a first light at a first angle;
a pixel electrode under the glass plate;
an insulator formed on the pixel electrode;
a plurality of reflectors on the insulator for reflecting the first light to a second light at a second angle to be further refracted by the glass plate to the output light;
a passivation on the plurality of reflectors and the insulator; and
a transparent conductor on the passivation.

2. The pixel structure of claim 1, wherein the transparent conductor is electrically connected to the pixel electrode by the plurality of reflectors.

3. The pixel structure of claim 1, wherein the transparent conductor is directly connected to the pixel electrode.

4. The pixel structure of claim 1, wherein each of the plurality of reflectors is oblique at a third angle.

5. The pixel structure of claim 4, wherein each of the plurality of reflectors comprises a high reflective metal.

6. The pixel structure of claim 4, wherein each of the plurality of reflectors comprises a high reflective multilayer coating.

7. The pixel structure of claim 4, wherein the plurality of oblique reflectors comprises:
a first group of reflectors each having a reflective surface with a third angle to the insulator for reflecting a first wavelength component of the first light;
a second group of reflectors each having a reflective surface with a fourth angle to the insulator for reflecting a second wavelength component of the first light; and
a third group of reflectors each having a reflective surface with a fifth angle to the insulator for reflecting a third wavelength component of the first light.

8. The pixel structure of claim 1, wherein each of the plurality of reflectors has an optical grating.

9. The pixel structure of claim 8, wherein the optical grating comprises one or more metal layers in stack.

10. The pixel structure of claim 8, wherein the optical grating comprises a high reflective multilayer coating.

11. The pixel structure of claim 8, wherein the plurality of reflectors comprises:
a first group of the optical gratings having a first period for reflecting a first wavelength component of the first light;
a second group of the optical gratings having a second period for reflecting a second wavelength component of the first light; and
a third group of the optical gratings having a third period for reflecting a third wavelength component of the first light.

12. The pixel structure of claim 1, wherein each of the plurality of reflectors comprises:
a planar reflective surface; and
a transparent element on the planar reflective surface for refracting the first light to be vertically incident on the planar reflective surface.

13. The pixel structure of claim 12, wherein the planar reflective surface comprises a high reflective metal.

14. The pixel structure of claim 12, wherein the transparent element comprises one or more microprisms.

15. The pixel structure of claim 12, wherein the plurality of reflectors comprises:
a first group of the transparent elements for refracting a first wavelength component of the first light;
a second group of the transparent elements for refracting a second wavelength component of the first light; and
a third group of the transparent elements for refracting a third wavelength component of the first light.

16. A method for an LCoS display to reflect an incident light at an incident angle to an output light at an output angle, the method comprising the steps of:
refracting the incident light to a first light at a first angle;
reflecting the first light to a second light at a second angle by a plurality of oblique reflectors; and
refracting the second light to the output light.

17. The method of claim 16, wherein the step of reflecting the first light comprises the steps of:
reflecting a first wavelength component of the first light by a first group of the reflectors each having a reflective surface oblique at a third angle;
reflecting a second wavelength component of the first light by a second group of the reflectors each having a reflective surface oblique at a fourth angle; and
reflecting a third wavelength component of the first light by a third group of the reflectors each having a reflective surface oblique at a fifth angle.

18. The method of claim 16, wherein the step of reflecting the first light comprises diffracting the first light.

19. A method for an LCoS display to reflect an incident light at an incident angle to an output light at an output angle, the method comprising the steps of:
refracting the incident light to a first light at a first angle;
reflecting the first light to a second light at a second angle by a plurality of optical gratings; and
refracting the second light to the output light.

20. The method of claim 19, wherein the step of reflecting the first light comprises the steps of:
reflecting a first wavelength component of the first light by a first group of the optical gratings having a first period;
reflecting a second wavelength component of the first light by a second group of the optical gratings having a second period; and
reflecting a third wavelength component of the first light by a third group of the optical gratings having a third period.

21. A method for an LCoS display to reflect an incident light at an incident angle to an output light at an output angle, the method comprising the steps of:
refracting the incident light to a first light at a first angle;
refracting the first light to a second light at a second angle by a plurality of transparent elements;
reflecting the second light to a third light at a third angle by a plurality of planar reflective surfaces;
refracting the third light to a fourth light at a fourth angle by the plurality of transparent elements;
refracting the fourth light to the output light.

22. The method of claim 21, wherein the step of refracting the first light comprises the steps of:
refracting a first wavelength component of the first light by a first group of the transparent elements;
refracting a second wavelength component of the first light by a second group of the transparent elements; and
refracting a third wavelength component of the first light by a third group of the transparent elements.

23. The method of claim 21, wherein the step of reflecting the second light comprises diffracting the second light.
